(19) United States
(12) Patent Application Publication
(10) Pub. No.: US 2011/0118979 A1
(43) Pub. Date: May 19, 2011

(54) AUTOMOTIVE LOCATION DATA INTEGRITY

(75) Inventors: Wei Mao, Santa Clara, CA (US); Lukas Marti, Santa Clara, CA (US)

(73) Assignee: Robert Bosch GmbH, Stuttgart (DE)

(21) Appl. No.: 12/621,745

(22) Filed: Nov. 19, 2009

(51) Int. Cl. G01C 21/26

(52) U.S. Cl. 701/208; 701/216

(57) ABSTRACT

A method of operating an automotive location system may include providing a timely warning if the system cannot satisfy predetermined performance criteria. An example method may include ascertaining a satellite-based position estimation ascertaining a dead reckoning position estimation, determining a location estimation by combining the satellite position estimation and the dead reckoning position estimation, determining a map-matching position, and determining an integrity of the location estimation by comparing a test statistic calculated by evaluating the map-matching position and the location estimation with a decision threshold based upon a predetermined location estimation accuracy specification. If the test statistic is less than the decision threshold, the system may provide the location estimation. If the test statistic is greater than the decision threshold, the system may provide an indication that the integrity of the location estimation does not satisfy the predetermined location estimation accuracy specification.

### BACKGROUND OF THE INVENTION

1. Field of the Invention

The present invention relates generally to automotive electronics such as automotive location systems and, more particularly, to the integrity of location information associated automotive location systems including satellite navigation systems, dead reckoning systems, and/or map data.

2. Description of the Related Art

The present disclosure contemplates that satellite navigation has increasing popularity in the automotive domain and that there are many automotive applications that rely on vehicle location estimation.

The present disclosure contemplates that in the aviation domain, receiver autonomous integrity monitoring (RAIM) may be used to assess the integrity of global positioning system (GPS) signals in a GPS receiver system. The following papers discuss RAIM in the aviation domain, and are incorporated by reference into this Background section: R. G. Brown and G. Chin, “GPS RAIM: Calculation of Threshold and Protection Radius Using Chi-Square Methods—A Geometric Approach”, Institute of Navigation Special Monograph Series, vol. 5, Alexandria, Va., 1998; and M. Brenner, “Integrated GPS/Inertial Fault Detection Availability”, Proceedings of ION GPS-95, Palm Springs, Calif., September 1995.

### SUMMARY OF THE INVENTION

In an aspect, a method of operating an automotive location estimation system may include ascertaining a satellite-based position estimation using a global navigation satellite system device; ascertaining a dead reckoning position estimation using an dead reckoning system; determining a location estimation by combining the satellite position estimation and the dead reckoning position estimation; determining a map-matching position by performing map matching using data associated with at least one of the satellite-based position and the dead reckoning position in connection with a map including a plurality of map features; determining an integrity of the location estimation by comparing a test statistic calculated by evaluating the map-matching position and the location estimation with a decision threshold based upon a predetermined location estimation accuracy specification; providing, if the test statistic is less than the decision threshold, the location estimation and the permissible error associated with the location estimation; and providing, if the test statistic is greater than the decision threshold, an indication that the integrity of the location estimation does not satisfy the predetermined location estimation accuracy specification.

In a detailed embodiment, evaluating the map-matching position and the location estimation may include considering a projection error, where the projection error may be defined as a difference between the location estimation and the map-matching position. In a detailed embodiment, evaluating the map-matching position and the location estimation may include comparing heading data from at least one of the global navigation satellite system and the dead reckoning system with a direction associated with a map feature.

In a detailed embodiment, ascertaining the dead reckoning position estimation using the dead reckoning system may include obtaining translation data from a wheel rotation sensor and obtaining heading data from a gyroscope. In a detailed embodiment, obtaining translation data from the wheel rotation sensor may include obtaining translation data from a wheel impulse sensor.

In a detailed embodiment, determining the integrity of the location estimation may include applying fuzzy logic to data associated with at least one of the plurality of map features. In a detailed embodiment, the predetermined location estimation accuracy specification may include a probability of missed detection and/or a probability of false alert. In a detailed embodiment, if the test statistic is less than the decision threshold, providing the location estimation may include providing the location estimation to at least one automotive application configured to provide a driver assistance function based at least in part upon the location estimation. In a detailed embodiment, if the test statistic is greater than the decision threshold, providing the indication that the integrity of the location estimation does not satisfy the predetermined location estimation accuracy specification may include providing the location estimation.

In an aspect, a method of operating an automotive application may include receiving at least one of a location estimation and a location estimation integrity alarm from an automotive navigation system, where the automotive navigation system ascertains the location estimation using at least a satellite-based position estimation from a global navigation satellite system and a dead reckoning position from a dead reckoning system; utilizing the location estimation to provide a driver assistance function, if the location estimation is received from the automotive navigation system; and providing a notification associated with potentially unreliable performance of the driver assistance function, if the location estimation integrity alarm is received from the automotive navigation system.

In a detailed embodiment, utilizing the location estimation to provide the driver assistance function may include providing at least one of a lane departure warning and a curve warning. In a detailed embodiment, utilizing the location estimation to provide the driver assistance function may include providing at least one interlinked driver assistance function. In a detailed embodiment, providing the notification associated with potentially unreliable performance of the driver assistance function may include disabling the driver assistance function. In a detailed embodiment, providing the notification associated with potentially reliable performance of the driver assistance function may include providing the driver assistance function utilizing the location estimation. In a detailed embodiment, receiving the at least one of the location estimation and the location estimation integrity alarm from the automotive navigation system may include receiving the location estimation integrity alarm based at least partially upon a comparison of the location estimation and a map-matching position estimation.

In an aspect, an automotive navigation system may include a global navigation satellite system device configured to provide a satellite-based position estimation; a dead reckoning device configured to provide a dead reckoning position estimation; a sensor fusion device configured to integrate the satellite-based position estimation and the dead reckoning position estimation to provide a location estimation; a map-matching component configured to provide a map-matching position estimation based upon a plurality of map features of a map; and a location estimation integrity output operative to selectively provide a notification that the location estimation does not satisfy a location estimation accuracy specification based upon consideration of the map-matching position estimation in connection with at least one of the satellite-based position estimation and the dead reckoning position estimation.

In a detailed embodiment, the dead reckoning device may include a heading sensor. In a detailed embodiment, the heading sensor may include a gyroscope.

In a detailed embodiment, the dead reckoning device may include a translation sensor. In a detailed embodiment, the translation sensor may include a wheel impulse sensor.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram of an exemplary automotive location integrity system.

FIG. 2 is a schematic diagram illustrating an exemplary scenario in which a position estimate is within a protection limit.

FIG. 3 is a schematic diagram illustrating an exemplary scenario in which a position estimate is outside of a protection limit.

FIG. 4 is a schematic diagram illustrating an exemplary scenario in which a protection limit is too large for the desired functionality.

FIG. 5 is a flow chart illustrating an example method of operating an automotive location estimation system.

FIG. 6 is a flow chart illustrating an example method of operating an automotive application.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DESCRIPTION OF THE PRESENT INVENTION

The present disclosure contemplates that the integrity of automotive location estimations may affect the safety of automotive applications relying on location estimations. In particular, automotive applications employed in liability and safety critical systems (e.g., applications which may execute a safety relevant or liability critical decision in real time) may utilize automotive location data, which may include errors. Some example embodiments according to the present disclosure may address the aspect of ensuring the integrity of the automotive location data, such as to provide a timely warning if the system cannot meet a specified performance criterion. In some example embodiments, a warning may be provided under a specified error probability, e.g., a probability of false alert and/or a probability of missed detection. Thus, some example embodiments may allow some automotive location system malfunctions and/or performance degradations to be detected at a very low error rate.

The present disclosure contemplates that global navigation satellite systems (GNSS), such as GPS, may be used as a primary means of navigation in the aviation domain for all phases of flight. As aeronautics has very stringent requirements in terms of safety, strict requirements on the performance of the GPS may be imposed. Hence, the concept of localization integrity stems from the aviation domain. Generally, a goal is to notify a pilot when she should trust the location estimate (e.g., that the estimation error is within an alarm limit) and/or when she should disregard the location estimate because it may be unreliable. As used herein, protection limit (also referred to as an alarm limit) generally refers to the permissible error associated with the location estimation.

The present disclosure contemplates that two basic approaches to location estimation integrity problems have been defined for the aviation domain. One is based on an augmentation system, which may be either space-based (e.g., European Geostationary Navigation Overlay Services (EGNOS) and Wide Area Augmentation System (WAAS)) or ground-based (e.g., Local Area Augmentation System (LAAS)). These methods, however, may be vulnerable to jamming and/or interference as suffered by the GPS signal itself.

The present disclosure contemplates that a second approach to the location estimation integrity problem may be algorithm-based. For example, the aviation industry has adopted the RAIM algorithm developed by R. Brown (see, e.g., R. G. Brown and G. Chin, “GPS RAIM: Calculation of Threshold and Protection Radius Using Chi-Square Methods—A Geometric Approach”, Institute of Navigation Special Monograph Series, vol. 5, Alexandria, Va., 1998). The RAIM algorithm monitors the GPS signal consistency using redundant measurements. For example, at least five satellite measurements are needed to achieve fault detection and six satellite measurements are needed to achieve fault exclusion. Such systems calculate a protection limit and provide an alarm indication based on a given set of false alarm rate and missed detection rate criteria. Typically, if the alarm is on, then the estimation error is larger than the protection limit, and, if the alarm is off, then the estimation error is said to be within the protection limit. If not enough satellites are available, then the check cannot be performed. An extension of the technique introduced above is the solution separation method developed by M. Brenner (see, e.g., M. Brenner, “Integrated GPS/Inertial Fault Detection Availability”, Proceedings of ION GPS-95, Palm Springs, Calif., September 1995), which also leverages an inertial sensor. It performs consistency checks on the fullset solution, which uses all GPS and inertial data, and the subset solutions, which use subsets of the GPS data. The outputs are similar to those of the RAIM algorithm.

The present disclosure contemplates that the aviation domain distinguishes among the following phases of flight: oceanic, en-route, terminal, and approach. The required navigation performance (RNP) is driven by the phase of flight, and may be defined as the navigation performance necessary for operation within a defined airspace. Whereas the oceanic phase can tolerate an RNP of 10 nautical miles (nmi), an approach phase may need a sub-meter RNP considering a Category IIIc precision approach (e.g., a precision instrument approach and/or landing with no decision height and no runway visual range limitations, and which may include guidance along the runway surface).

The present disclosure contemplates that the automotive domain may not distinguish between different phases of drive, and generally about a meter to sub-meter RNP may be useful for many automotive applications. Although the integrity algorithms are available from aviation, they cannot be directly applied to automotive applications because the protection limit using only GPS signals or using GPS signals in connection with inertial data is typically on the order of about tens to hundreds of meters. In contrast, some automotive applications may benefit from protection limits of less than or on the order of about ten meters, or even on the order of less than a meter.

In some example embodiments, an automotive location system according to the present disclosure may utilize GPS data, dead reckoning data (such as wheel rotation data and/or heading data), and/or map data to provide a high location estimate accuracy and/or determine the integrity of the location estimate. If the location estimate integrity is not within a predetermined specification, the system may provide a user (e.g., a driver) with a timely warning. Some example embodiments may employ statistical inference to provide such a warning.

The present disclosure contemplates that automotive electronic applications may include standalone driver assistance (DA) systems as well as interlinked systems, e.g., C2X systems (car-to-car (C2C) systems and/or car-to-infrastructure (C2I) systems). Some such applications may not relate to driver safety (e.g., an application which may list the closest shopping centers in the vicinity), while some driver assistance applications may have a potentially significant impact on driver safety and/or liability. The driver safety related systems and liability related systems may be distinguished based on the potential consequences of a failure of the system. In general, failures of liability critical systems may cause monetary losses, while safety critical systems may result in passengers being harmed.

The present disclosure contemplates that even though the design philosophy of driver assistance systems (and other automotive applications) may assign the decision responsibility for safe operation to the driver, a driver may unconsciously rely on a driver assistance system and/or information provided by the driver assistance system. Thus, a malfunction of some driver assistance systems may present some safety risks. Hence, even though the design philosophy may allocate safety-related decision-making to a driver, driver assistance systems may contribute to safety by providing high integrity information and/or by notifying the driver when the driver assistance systems should not be relied upon.

Localization information may play a key role in some automotive application functionalities, for standalone as well as interlinked systems. For example, a standalone driver assistance application utilizing localization data may include a lane departure warning (which may provide an alert that the vehicle has deviated from a particular lane) and/or a curve warning (which may provide an alert that the vehicle is approaching a curve in the road for which reducing the vehicle's speed would be appropriate). Example interlinked driver assistance systems utilizing localization data may include systems that notify a driver of an upcoming traffic signal (e.g., a red and/or yellow signal) and/or that a nearby car is braking (which may indicate, for example, stopped traffic ahead).

In some cases, position estimate integrity may be considered in the context of sensors and/or applications. Sensor integrity may refer to the probability that the sensor system (e.g., a GPS sensor) operates within its specification. Application integrity in the context of DA or C2X systems employing sensor data may refer to the probability of the application working within its specifications. Similarly, a loss of application integrity may refer to an undetected false operation of the application. It is hence noted that as long as the application is capable of detecting unsafe operation of the sensor system (e.g., degradation of the GPS position accuracy potentially resulting in excessive location estimation errors), the application integrity may be ensured.

The present disclosure contemplates that although consumer localization devices are quite popular, they may not be sufficient for many automotive applications for two reasons. First, location estimation accuracy of some consumer localization devices may not be sufficient for safety critical applications. Second, integrity information, which may be used to protect the system from erroneous performance and/or report in real-time if the localization accuracy can not be met, is typically missing from many consumer localization devices. Many consumer localization devices merely display a disclaimer message at startup to avert liability from the manufacturer. Such an approach may be insufficient for some safety-related or liability critical functionalities.

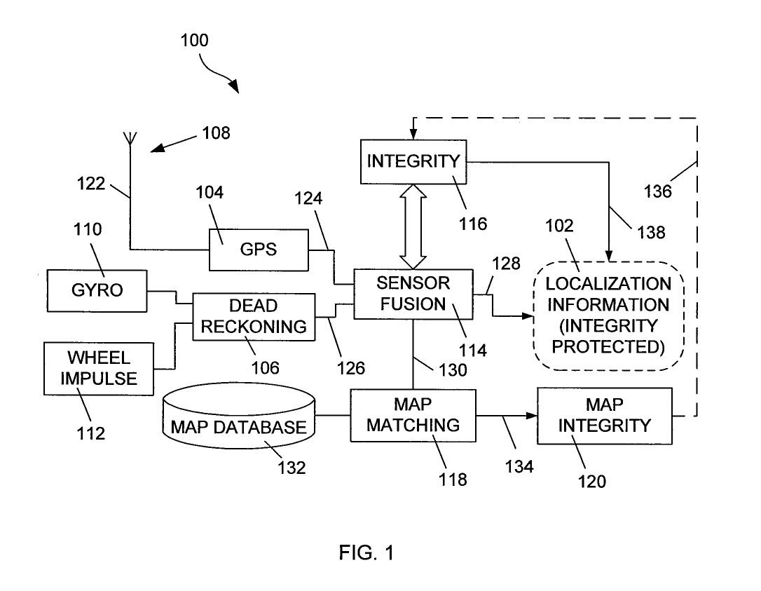

FIG. 1 schematically illustrates an example automotive localization integrity system 100, which may provide integrity protected localization information 102 to an automotive application based upon data associated with a global navigation satellite system device, such as a GPS receiver 104 (which may include an antenna 108), and/or a dead reckoning system 106, which may receive data associated with a heading (e.g., rotation around the Z-axis) and/or translation. For example, a gyroscope system 110, such as a MEMS gyroscope system, may provide data pertaining to an automobile's heading and/or a wheel rotation sensor system such as wheel impulse system 112 may provide data pertaining to the automobile's translation. In some example embodiments, GPS receiver 104 and/or dead reckoning system 106 may be operatively connected to a sensor fusion component 114, which may be operatively connected to an integrity component 116 and/or to a map matching component 118. Map matching component 118 may be operatively connected to integrity component 116 via a map integrity component 120.

An example automotive localization integrity system may operate as follows. A GPS satellite signal 122 may be received by antenna 108 and provided to GPS receiver 104. GPS receiver 104 may provide data, such as GPS raw range measurements 124 (e.g., pseudoranges) to sensor fusion component 114. Dead reckoning system 106 may provide a dead reckoning position solution 126 (which may be generated based upon data from gyro system 110 and/or wheel impulse system 112 and/or which may be converted into the GPS measurement domain) to sensor fusion component 114. Sensor fusion component 114 may utilize the GPS raw range measurements 124 and/or the dead reckoning position solution 126 to develop a location estimation 128, which may be included in localization information 102 and/or which may be provided to integrity component 116. In some example embodiments, the GPS/dead reckoning integration performed by sensor fusion component 114 may be effected using Kalman Filters.

In some example embodiments, sensor fusion component 114 may provide filter data 130 (such as covariance data and/or position estimates) to map matching component 118. Map matching component 118 may utilize filter data 130 and/or map database 132 to develop map matching data 134, which may include determining a map-matching position by validating map features, segment data, and/or a location on a map segment, for example. The use of the map database 132 may provide additional information, thus allowing for further consistency validation. Map-matching data 134 may be provided to a map integrity component 120, which may develop and provide to integrity component 116 a quantitative match 136 of map features (such as segment position, segment heading, etc.) to the filter estimate. In some example embodiments, quantitative match 136 may be may transformed into the GPS measurement domain. Integrity component 116 may determine location estimation integrity 138 of location estimation 128 based upon the information received from sensor fusion component 114 and/or quantitative match 136, and the location estimation integrity 138 may be included in localization information 102.

In some example embodiments, GPS raw range measurements 124 and/or dead reckoning position solution 126 may be used with or without map data to provide integrity verification and/or a position estimate. The integrity verification for GPS/dead reckoning may be achieved through a solution separation algorithm or its variants, generally in the manner described in M. Brenner, “Integrated GPS/Inertial Fault Detection Availability”, Proceedings of ION GPS-95, Palm Springs, Calif., September 1995.

### Example Implementation

Based on the global navigation satellite system constellation and measurement noise, as well as a predefined acceptable probability of missed detection (P_{MD}) (e.g., the probability that the system will not detect an unsafe condition) and/or acceptable probability of false alert (P_{FA}) (e.g., the probability that the system will erroneously report an unsafe condition), a Protection Limit (PL) may be evaluated. The PL may be interpreted as a “fundamental possible system” performance. Specifically, the PL may be defined as the radius of a circle centered at the actual position which is guaranteed to contain the estimated position to within the specifications of the integrity scheme (e.g., which meets the P_{MD} and P_{FA} requirements). In some example embodiments, PL may depend on characteristics of a GNSS, such as the number of tracked satellites, the quality of satellite measurements in stochastic terms, and/or the satellite constellation arrangement (e.g., geometrical distribution).

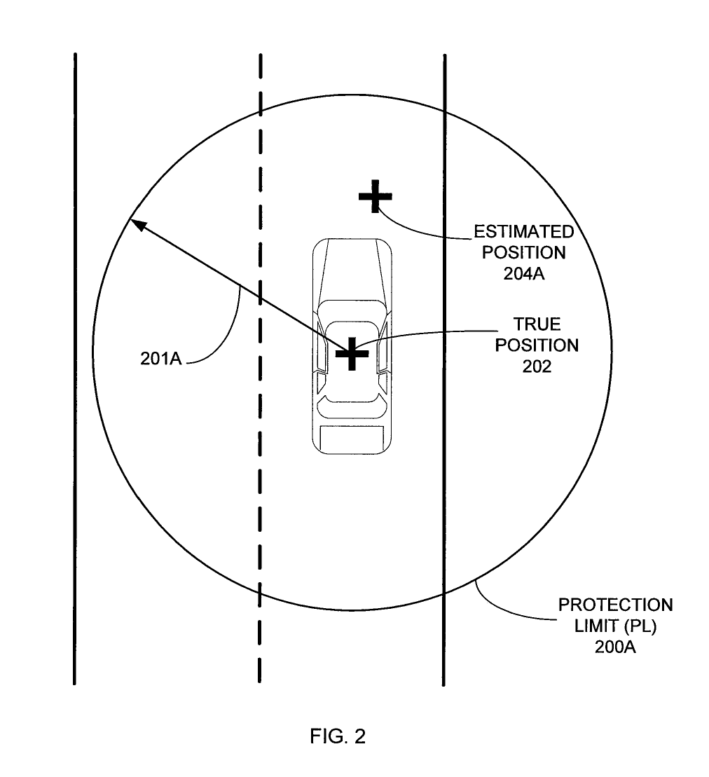

FIG. 2 illustrates an example PL 200A, which indicates the fundamental system performance (e.g., the PL 200A, based on the received satellite constellation, as well as the ranging measurement performance). As discussed above, PL 200A may comprise a circle having a radius 201A and centered at the true position 202. True position 202 is the actual position, and estimated position 204A may be the GPS-determined position.

Several operational scenarios are possible: (a) the estimated position is within the PL, (b) the estimated position is outside the PL, and (c) the PL is too large for the desired functionality.

Scenario (a) is illustrated in FIG. 2. In this scenario, safe application operation is guaranteed and the system is available because the estimated position 204A is within the PL 200A and the PL is small enough to provide the desired functionality (e.g., a DA application providing a curve warning).

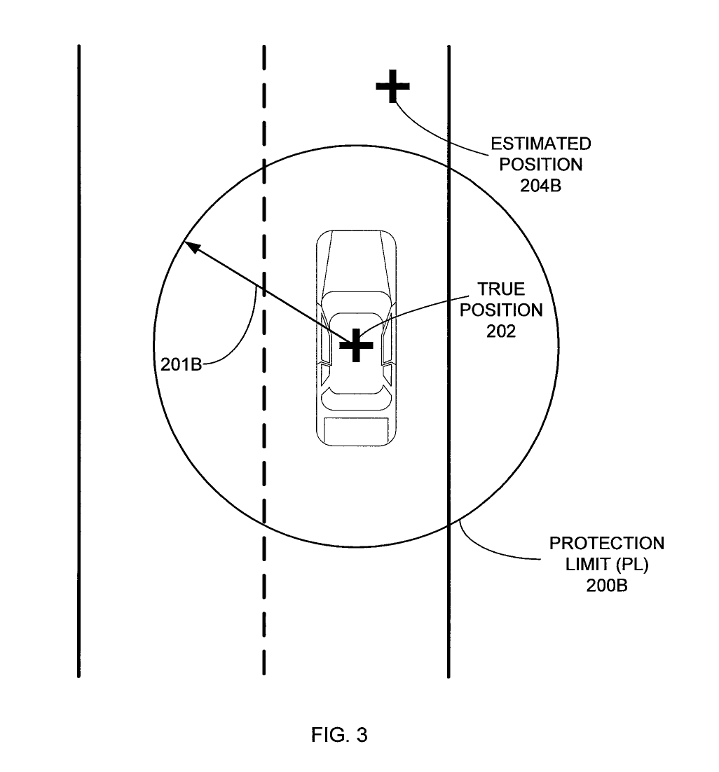

FIG. 3 illustrates scenario (b) in which the estimated position 204B is outside the PL 200B. In this scenario, the application using the localization data may not be available (and/or the user may be notified that the application is not available) because the estimated position 204B falls outside the PL 200B.

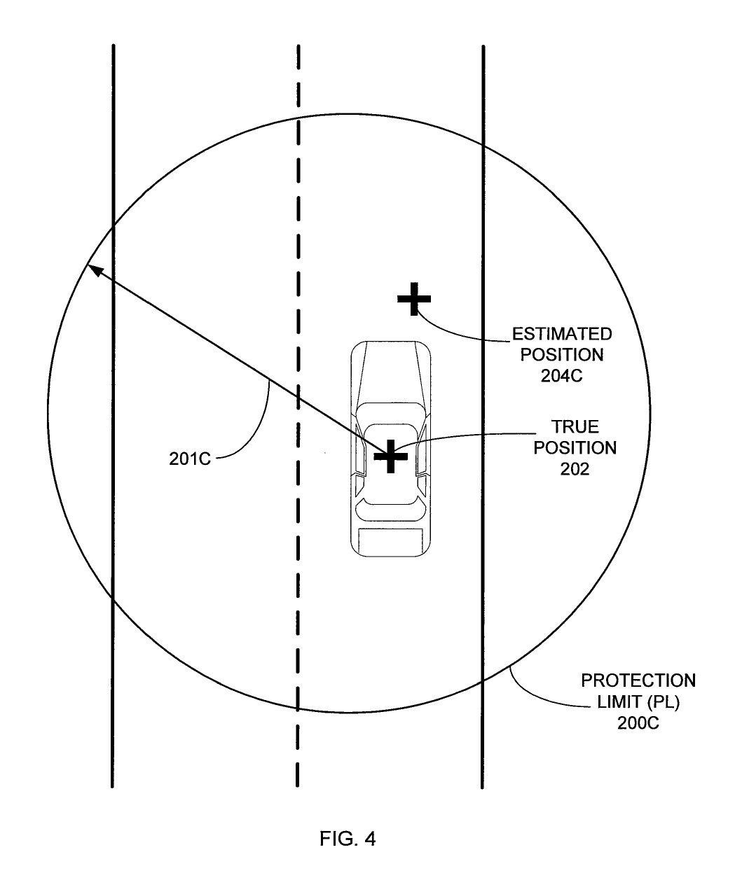

FIG. 4 illustrates scenario (c), which includes a failure mode where the PL 200C is too large for the desired functionality. As discussed above, PL 200C may be a function of the satellite constellation in terms of distribution and number of available satellites and/or the ranging measurement noise under nominal performance. Each application use case, e.g., C2X or DA functionality, may be subject to a Minimal Operational Requirement. If, for example, the application includes a driver assistance function providing a lane departure warning, sub-meter accuracy may be necessary to determine that an automobile is deviating from a particular lane. Thus, as illustrated in FIG. 4, PL 200C may be too large to satisfy the lane departure warning functionality. In such a circumstance, a driver may be notified that the lane departure warning application is not operating, or may be operating with degraded performance.

In practice, because some example systems may not be capable of ascertaining an actual position in addition to an estimated position, some example systems may compare a test statistic to a decision threshold to maintain safe operation. For example, determination of a test statistic may include consideration of a GPS pseudorange measurement residual (e.g., the difference between the expected measurement and the observed measurement) and/or the amount of redundancy in the GPS data as described in R. G. Brown and G. Chin, “GPS Calculation of Threshold and Protection Radius Using Chi-Square Methods—A Geometric Approach”, Institute of Navigation Special Monograph Series, vol. 5, Alexandria, Va., 1998. As another example, determination of a test statistic may include the solution separation method developed by M. Brenner (see, e.g., M. Brenner, “Integrated GPS/Inertial Fault Detection Availability”, Proceedings of ION GPS-95, Palm Springs, Calif., September 1995).

In some example embodiments employing map matching, a test statistic may be determined at least in part based upon the quantitative match 136 of map features. Quantitative match 136 may be calculated at least in part using fuzzy logic, which may consider various aspects of map-matching data 134. For example, the fuzzy logic may consider the projection error, which may be defined as difference between the location estimation 128 and a map-matching-based position estimation. As another example, the fuzzy logic may consider a measured heading (which may be determined from GPS receiver 104 and/or dead reckoning system 106, and/or data provided by either or both of them) as compared to a direction associated with a map segment. For example, if the map-matching-based position estimation lies on or near a road, the fuzzy logic may consider the difference between a measured heading and the direction of the road. The fuzzy logic may consider other map features, such as a sharp turn near a known intersection and/or a measured track that falls generally parallel with but spaced apart from a road centerline, such as might occur if an automobile was driving in an outer lane of a multi-lane highway. In considering map-matching features to calculate quantitative match 136, the fuzzy logic may allocate differing weights to different map-matching features based upon, for example, the expected relevance of individual map-matching feature.

In some example embodiments, the test statistic may be compared with a predetermined decision threshold, which may be established such that the P_{MD} and/or P_{FA} requirements are satisfied. If the test statistic is less than the decision threshold, then the location estimation may be relied upon (e.g., the location estimation is sufficiently reliable to satisfy the P_{MD} and P_{FA} requirements). If the test statistic is greater than the decision threshold, then the location estimation is not sufficiently reliable to satisfy the P_{MD} and P_{FA} requirements. Accordingly, an application utilizing the location estimation may not be available and/or the user may be notified that the application and/or location estimation does not satisfy the predetermined specifications. As long as the test statistic notices the inconsistency (e.g., test statistic being larger than the decision threshold), safe application operation can be guaranteed, as the sensor system detects the measurement inconsistency.

Based on this framework, example operational modes of an application functionality are summarized in the following table:

| Estimation | Test | PL < | |
|---|---|---|---|
| Error < | Statistic < | Use Case | |
| PL | DT | Requirement | |
| Y | Y | Y | Safe operation |
| | | | System available |
| Y | N | Y | False Alert (Sensor Integrity |
| | | | False Alert) |
| N | Y | Y | UNSAFE OPERATION |
| | | | Missed detection (Loss of Sensor |
| | | | Integrity undetected) |
| X | X | N | Safe Operation |
| | | | Application not available (Minimal |
| | | | Operational Requirement can not |
| | | | be satisfied) |
| N | N | Y | Safe operation |
| | | | Application not available (Loss |
| | | | of Sensor Integrity) |

As mentioned above, in some real systems, the left column may not be ascertainable because the systems may not be capable of determining the actual position and therefore may not be capable of determining the estimation error. However, the second column reflects efforts to deduce similar information using the test statistic. It is noted that within the domain of safety critical applications, as long as the sensor system is capable of detecting an inconsistency, safe operation on the application can be guaranteed. This is based on the rationale that application integrity is maintained as long as loss of sensor integrity can be detected. In some example embodiments, individual application functionalities may be associated with a contingency plan, which may specify the system operation mode for circumstances when a specific functionality cannot be executed due to a loss of sensor integrity. Example parameters associated with integrity are not limited to the protection limit and/or alarm limit as discussed above.

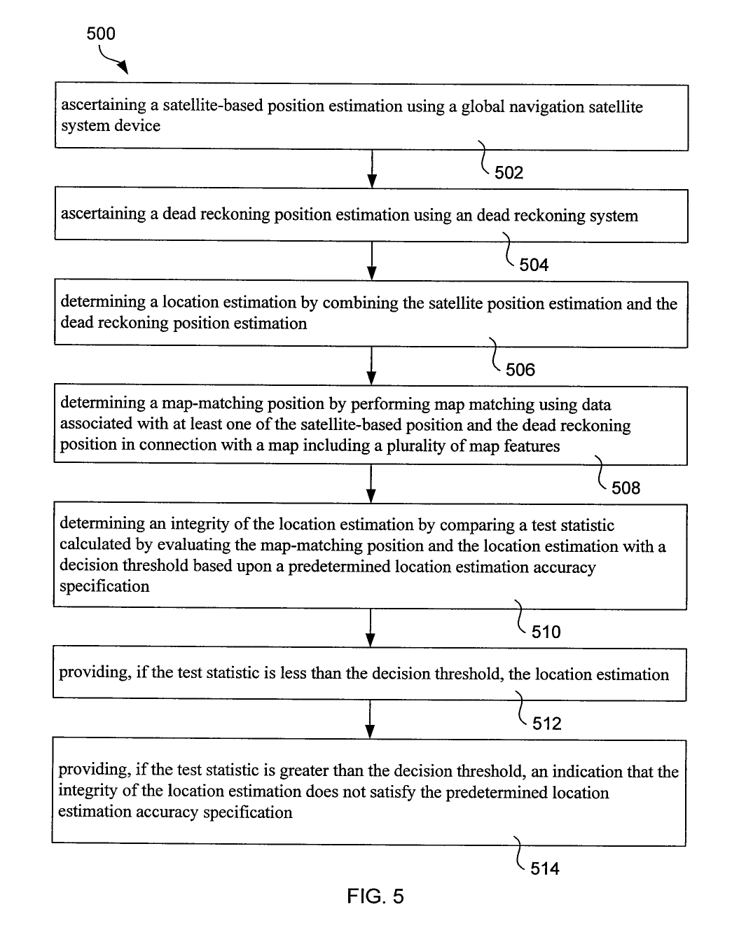

FIG. 5 illustrates an example method 500 of operating an automotive location estimation system. Operation 502 may include ascertaining a satellite-based position estimation using a global navigation satellite system device. Operation 504 may include ascertaining a dead reckoning position estimation using a dead reckoning system. Operation 506 may include determining a location estimation by combining the satellite position estimation and the dead reckoning position estimation. Operation 508 may include determining a map-matching position by performing map matching using data associated with at least one of the satellite-based position and the dead reckoning position in connection with a map including a plurality of map features. Operation 510 may include determining an integrity of the location estimation by comparing a test statistic calculated by evaluating the map-matching position and the location estimation with a decision threshold based upon a predetermined location estimation accuracy specification. Operation 512 may include providing, if the test statistic is less than the decision threshold, the location estimation. Operation 514 may include providing, if the test statistic is greater than the decision threshold, an indication that the integrity of the location estimation does not satisfy the predetermined location estimation accuracy specification.

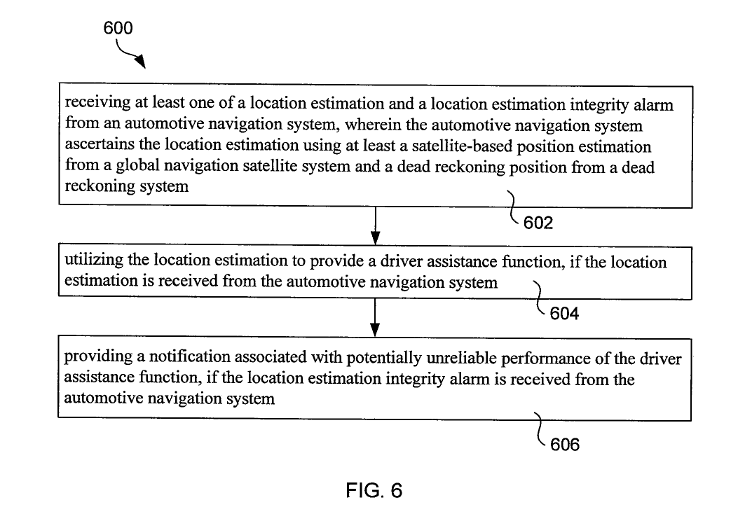

FIG. 6 illustrates an example method 600 of operating an automotive application. Operation 602 may include receiving at least one of a location estimation and a location estimation integrity alarm from an automotive navigation system, wherein the automotive navigation system ascertains the location estimation using at least a satellite-based position estimation from a global navigation satellite system and a dead reckoning position from a dead reckoning system. Operation 604 may include utilizing the location estimation to provide a driver assistance function, if the location estimation is received from the automotive navigation system. Operation 606 may include providing a notification associated with potentially unreliable performance of the driver assistance function, if the location estimation integrity alarm is received from the automotive navigation system.

It will be understood by those of skill in the art that various components and functions described herein may be implemented using hardware, software, and/or combinations of hardware and software. Accordingly, terms such as component, device, system, and the like may refer to physical devices and/or software implementations of such devices, or any combination thereof.

The present invention as described above may include several novel features. One such novel feature may be a system that employs GPS, odometry, gyroscope, and map data in combination to provide location estimation and integrity information. Another such novel feature may be a GPS system that provides location estimation along with integrity information. Yet another such novel feature may be a vehicle that employs an application that relies on integrity information, and wherein the vehicle warns or alarms the user not to use the application when the integrity relied upon by the application does not meet a minimum standard.

While this invention has been described as having an exemplary design, the present invention may be further modified within the spirit and scope of this disclosure. This application is therefore intended to cover any variations, uses, or adaptations of the invention using its general principles.

What is claimed is:

1. A method of operating an automotive location estimation system, the method comprising:
ascertaining a satellite-based position estimation using a global navigation satellite system device;
ascertaining a dead reckoning position estimation using a dead reckoning system;
determining a location estimation by combining the satellite position estimation and the dead reckoning position estimation;
determining a map-matching position by performing map matching using data associated with at least one of the satellite-based position and the dead reckoning position in connection with a map including a plurality of map features;
determining an integrity of the location estimation by comparing a test statistic calculated by evaluating the map-matching position and the location estimation with a decision threshold based upon a predetermined location estimation accuracy specification;
providing, if the test statistic is less than the decision threshold, the location estimation; and
providing, if the test statistic is greater than the decision threshold, an indication that the integrity of the location estimation does not satisfy the predetermined location estimation accuracy specification.

2. The method of claim 1, wherein evaluating the map-matching position and the location estimation includes considering a projection error, where the projection error is defined as a difference between the location estimation and the map-matching position.

3. The method of claim 1, wherein evaluating the map-matching position and the location estimation includes comparing heading data from at least one of the global navigation satellite system and the dead reckoning system with a direction associated with a map feature.

4. The method of claim 1, wherein ascertaining the dead reckoning position estimation using the dead reckoning system includes obtaining translation data from a wheel rotation sensor and obtaining heading data from a gyroscope.

5. The method of claim 4, wherein obtaining translation data from the wheel rotation sensor includes obtaining translation data from a wheel impulse sensor.

6. The method of claim 1, wherein determining the integrity of the location estimation includes applying fuzzy logic to data associated with at least one of the plurality of map features.

7. The method of claim 1, wherein the predetermined location estimation accuracy specification includes a probability of missed detection and a probability of false alert.

8. The method of claim 1, wherein providing, if the test statistic is less than the decision threshold, the location estimation, includes providing the location estimation to at least one automotive application configured to provide a driver assistance function based at least in part upon the location estimation.

9. The method of claim 1, wherein providing, if the test statistic is greater than the decision threshold, the indication that the integrity of the location estimation does not satisfy the predetermined location estimation accuracy specification, includes providing the location estimation.

10. A method of operating an automotive application, the method comprising:
receiving at least one of a location estimation and a location estimation integrity alarm from an automotive navigation system, wherein the automotive navigation system ascertains the location estimation using at least a satellite-based position estimation from a global navigation satellite system and a dead reckoning position from a dead reckoning system;
utilizing the location estimation to provide a driver assistance function, if the location estimation is received from the automotive navigation system; and
providing a notification associated with potentially unreliable performance of the driver assistance function, if the location estimation integrity alarm is received from the automotive navigation system.

11. The method of claim 10, wherein utilizing the location estimation to provide the driver assistance function includes providing at least one of a lane departure warning and a curve warning.

12. The method of claim 10, wherein utilizing the location estimation to provide the driver assistance function includes providing at least one interlinked driver assistance function.

13. The method of claim 10, wherein providing the notification associated with potentially unreliable performance of the driver assistance function includes disabling the driver assistance function.

14. The method of claim 10, wherein providing the notification associated with potentially unreliable performance of the driver assistance function includes providing the driver assistance function utilizing the location estimation.

15. The method of claim 10, wherein receiving the at least one of the location estimation and the location estimation integrity alarm from the automotive navigation system includes receiving the location estimation integrity alarm based at least partially upon a comparison of the location estimation and a map-matching position estimation.

16. An automotive navigation system comprising:
a global navigation satellite system device configured to provide a satellite-based position estimation;
a dead reckoning device configured to provide a dead reckoning position estimation;
a sensor fusion device configured to integrate the satellite-based position estimation and the dead reckoning position estimation to provide a location estimation;
a map-matching component configured to provide a map-matching position estimation based upon a plurality of map features of a map; and
a location estimation integrity output operative to selectively provide a notification that the location estimation does not satisfy a location estimation accuracy specification based upon consideration of the map-matching position estimation in connection with at least one of the satellite-based position estimation and the dead reckoning position estimation.

17. The automotive navigation system of claim 16, wherein the dead reckoning device includes a heading sensor.

18. The automotive navigation system of claim 17, wherein the heading sensor includes a gyroscope.

19. The automotive navigation system of claim 16, wherein the dead reckoning device includes a translation sensor.

20. The automotive navigation system of claim 19, wherein the translation sensor includes a wheel impulse sensor.
